(19) United States
(12) Patent Application Publication
(10) Pub. No.: US 2025/0313024 A1
(43) Pub. Date: Oct. 9, 2025

(54) DEFECTIVE INKJET COMPENSATION USING HALFTONE SCREEN PERMUTATIONS

(71) Applicant: Xerox Corporation, Norwalk, CT (US)

(72) Inventors: Stuart A. Schweid, Pittsford, NY (US); Douglas R. Taylor, Webster, NY (US)

(73) Assignee: Xerox Corporation, Norwalk, CT (US)

(21) Appl. No.: 18/627,952

(22) Filed: Apr. 5, 2024

(51) Int. Cl. B41J 29/367; B41J 2/205; B41J 29/393

(52) U.S. Cl. CPC B41J 29/367; B41J 2/205; B41J 29/393; B41J 2029/3935

(57) ABSTRACT

A method for compensating for defective ink jets includes, for an original halftone screen including cells arranged in columns and rows, each cell comprising a threshold value, identifying a first column in the original halftone screen corresponding to a defective inkjet in a marking device. A permuted halftone screen is generated from the original halftone screen with a protocol which includes, for each row in the original halftone screen, providing for swapping a threshold value of a cell in the identified first column with threshold values in cells of neighboring columns, such that the first column assumes the largest threshold value of: the threshold value in the identified first column, a threshold value in a first of the neighboring columns, and a threshold value in a second of the neighboring columns. The permuted screen is stored for halftoning an input image to be printed by the marking device.

### BACKGROUND

The exemplary embodiment relates to inkjet printing and finds particular application in connection with a system and method for compensating for defective inkjets by permutations of a halftone screen.

Inkjet printers eject liquid ink from printheads onto a print medium, such as paper, or an intermediate transfer surface, to form images. The printheads each include an array of inkjets or “nozzles” which are selectively actuated to provide a droplet of ink, which is directly or indirectly deposited on the print medium.

The nozzles tend to become blocked or clogged over time. This may occur for a variety of reasons, but it is often associated with contamination or long latency periods. When a blockage occurs, the affected nozzles are unable to eject the ink droplets, which degrades the quality of the printed image. Commonly observed artifacts of defective (or “missing”) nozzles include missing dots and striations, which are streaks of a lighter color.

To address the problem, the nozzles may be periodically purged with fresh ink. However, this is time consuming and uses a considerable amount of ink. Much of the purging ink is essentially wasted, since most of the nozzles are likely to be operating normally. Moreover, if the cause of the blockage is not identified, the inoperative nozzles may soon become blocked again.

Another approach for mitigating the effects of fully or partially nonfunctional nozzles is to employ redundant (“substitute”) nozzles. These can compensate, to some degree, for the missing ones. However, adding nozzles is very costly.

In inkjet systems, missing jet compensation is commonly performed as a post processing step after halftoning. The binary halftone image is modified by moving drops targeted for non-functioning jets to neighboring jets. This preserves the ink usage locally and is able to mask the defective jets in the printed image. The algorithm is performed at the time of printing. The algorithms thus tend to rely on high power computing resources, such as field-programmable gate arrays (FPGA). These are configurable integrated circuits that can be programmed or reprogrammed after manufacturing. Software (CPU/GPU) resources may also be used. For smaller printing devices, the cost of the additional hardware or software may be prohibitive.

Missing jet algorithms are typically performed serially, each drop of a defective jet is moved, in turn, to an alternative location. Pixel locations that are available to have defective jets reassigned to are “used up” during the process. Thus, available pixels at the beginning of the algorithm are no longer available as the process progresses.

While this type of algorithm is suited to FPGA and CPUs that serially process an image, such algorithms are not amenable to GPUs, which process an image in parallel.

Described herein is a method and system for compensating for defective jets by modifying the halftone screen.

### INCORPORATION BY REFERENCE

The following references are incorporated herein by reference in their entireties.

Methods for addressing defective inkjets are described, for example, in U.S. Pub. No. 20060285131A1, published Dec. 21, 2006, entitled COMPENSATION FOR MALFUNCTIONING JETS, by Mantell, et al.; U.S. Pub. No. 20110304665A1, published Dec. 15, 2011, entitled SYSTEM AND METHOD TO COMPENSATE FOR DEFECTIVE INKJETS IN AN INKJET IMAGING APPARATUS, by Mantell; U.S. Pat. No. 9,561,644B1, issued Feb. 7, 2017, entitled SYSTEM AND METHOD FOR COMPENSATING FOR MALFUNCTIONING INKJETS, by Clark, et al.; U.S. Pub. No. 20110141171A1, published Jun. 16, 2011, entitled SYSTEM AND METHOD FOR COMPENSATING FOR SMALL INK DROP SIZE IN AN INDIRECT PRINTING SYSTEM, by Folkins, et al.; U.S. Pub. No. 20220234358A1, published Jul. 28, 2022, entitled INTELLIGENT IDENTIFICATION AND REVIVING OF MISSING JETS BASED ON CUSTOMER USAGE, by Steurrys, et al.

Halftone screening methods are described, for example, in U.S. Pat. Nos. 4,876,611; 4,149,194; 5,394,252; and U.S. Pub. No. 20120274985A1.

Methods of cleaning inkjets are described, for example, in U.S. Pub. No. 20230226821A1, published Jul. 20, 2023, entitled SYSTEM AND METHOD FOR COMMENCING PRINTING OPERATIONS IN AN INKJET PRINTER, by Barrese, et al.

### BRIEF DESCRIPTION

In accordance with one aspect of the exemplary embodiment, a method for compensating for defective ink jets is provided. The method includes, for an original halftone screen including cells arranged in columns and rows, each cell comprising a threshold value, identifying a first column in the original halftone screen corresponding to a defective inkjet in a marking device. A permuted halftone screen is generated from the original halftone screen with a protocol which includes, for each row in the original halftone screen, providing for swapping a threshold value of a cell in the identified first column with threshold values in cells of neighboring columns, such that the first column assumes the largest threshold value of: the threshold value in the identified first column, a threshold value in a first of the neighboring columns, and a threshold value in a second of the neighboring columns. The permuted screen is stored for halftoning an input image to be printed by the marking device.

In accordance with another aspect of the exemplary embodiment, a printing system includes a marking device including inkjets and a controller, in communication with the marking device. The controller stores instructions which, for an original halftone screen including cells arranged in columns and rows, each cell including a threshold value, identify a first column in the original halftone screen corresponding to a defective inkjet in the marking device. The instructions generate a permuted halftone screen from the original halftone screen with a protocol. The protocol includes, for each row in the original halftone screen, providing for swapping a threshold value of a cell in the identified first column with threshold values in cells of neighboring columns, such that the first column assumes the largest threshold value of the threshold value in the identified first column, a threshold value in a first of the neighboring columns, and a threshold value in a second of the neighboring columns. The instructions store the permuted screen for halftoning an input image to be printed by the marking device.

In accordance with another aspect of the exemplary embodiment, a method for compensating for defective ink jets of a marking device when printing an image. The method includes providing a permuted halftone screen which has been generated from an original halftone screen, the original screen comprising an array of threshold values. The permuted halftone screen has been generated with a protocol which includes swapping ones of the threshold values, each corresponding to a defective inkjet, with neighboring threshold values that are larger. The permuted screen is used to halftone an input image. The halftoning includes comparing contone values of the input image with threshold values in the permuted screen to generate a halftone image.

### BRIEF DESCRIPTION OF THE DRAWINGS

FIG. 1 is a functional block diagram of an inkjet printing system in accordance with one aspect of the exemplary embodiment;

FIG. 2 is a functional block diagram of one embodiment of a controller for the inkjet printing system of FIG. 1;

FIG. 3 illustrates a portion of an original halftone screen;

FIG. 4 illustrates a portion of a binary halftone image generated by processing a contone image with the halftone screen of FIG. 3;

FIG. 5 is a flow chart illustrating a method of permuting a halftone screen for compensating for defective ink jets;

FIG. 6 illustrates a portion of a permuted halftone screen, generated from the original halftone screen of FIG. 3 by swapping threshold values in a defective inkjet column with nearest neighbors having larger threshold values;

FIG. 7 illustrates a portion of a permuted halftone screen, generated from the permuted halftone screen of FIG. 6 by circularizing threshold values in the defective inkjet column in a first direction;

FIG. 8 illustrates a portion of a permuted halftone screen, generated from the permuted halftone screen of FIG. 7, by swapping threshold values in the defective inkjet column with nearest neighbors having larger threshold values;

FIG. 9 illustrates a portion of a permuted halftone screen, generated from the permuted halftone screen of FIG. 8, by swapping threshold values in the defective inkjet column with nearest neighbors having larger threshold values;

FIG. 10 illustrates a portion of a permuted halftone screen, generated from the permuted halftone screen of FIG. 9, by circularizing and swapping threshold values in the defective inkjet column with second nearest neighbors having larger threshold values, circularizing back, followed by circularizing in the opposite direction and swapping threshold values in the defective inkjet column with second nearest neighbors having larger threshold values and circularizing back;

FIG. 11 illustrates a permuted screen composed of four sub-screens; and

FIG. 12 is a flow chart illustrating a method for compensating for defective ink jets which includes permuting a halftone screen.

### DETAILED DESCRIPTION

Aspects of the exemplary embodiment relate to a system and method for modifying an original halftoning screen to compensate for defective halftone inkjets. The aim is to decrease the amount of ink deposited by defective inkjets in an inkjet marking device and increase the amount of ink deposited by neighboring inkjets. This is accomplished by permuting the threshold values of the halftone screen into different locations. The result is a permuted screen for which a histogram of threshold values remains unchanged over the screen. This ensures that for every input gray level, the number of drops (or amount of ink) commanded to the printheads will be identical for the permuted screen and the original screen.

Halftoning, as used herein, refers to the process of converting input image data (contone data) to binary or multi-level image data representing the inkjet drops to be printed. Halftoning may be accomplished with a halftone screen for each color separation (e.g., C, M, Y, and K). The halftone screen may be tessellated, i.e., repeated multiple times, to encompass an input image.

As used herein, a printing device can include any device for rendering an image on print media, such as a copier, laser printer, bookmaking machine, facsimile machine, or a multifunction machine (which includes one or more functions such as scanning, printing, archiving, emailing, and faxing). “Print media” can be a usually flimsy physical sheet of paper, plastic, or other suitable physical print media substrate for images. A “document” is normally a set of related sheets, usually one or more collated copy sets copied from a set of original print job sheets or electronic document page images, from a particular user, or otherwise related.

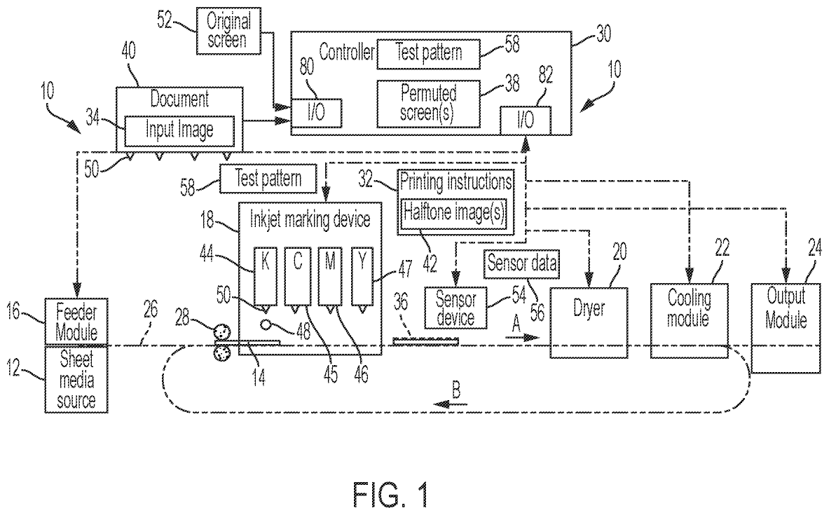

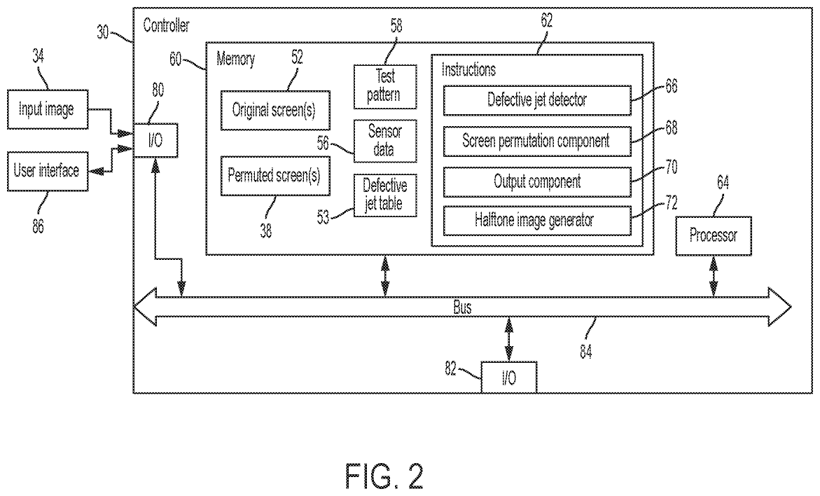

With reference to FIG. 1, an illustrative inkjet printing device 10 includes a source 12 of print media, such as sheets 14 or a continuous web, a print media feeder 16, at least one inkjet marking device 18, a print media dryer 20, for drying the printed media, optionally a cooling module 22, for cooling the dried media, and an output module 24, such as one or more output trays, all connected by a print media path 26. A print media transport system 28 conveys the print media, e.g. sheets, along the print media path 26, downstream from the feeder 16, and ultimately to the output module 24. The print media path 26 may be a simplex path or a duplex path having a main path, which transports print media in the direction of arrow A, and a return loop, along which the print media returns to the marking device 18 in the direction of arrow B. A controller 30, shown in greater detail in FIG. 2, controls the operation of some or all of the components 16, 18, 20, 22, 24, and 28 of the printing device 10. In particular, the controller provides printing instructions 32 to the marking device 18 for rendering an input image 34 as a printed image (or images) 36 on an image receiving surface of the print media 14. In generating the printing instructions 32, the controller 30 compensates for defective inkjets in the marking device 18. This is achieved, at least in part, by applying a permuted halftone screen 38 to the input image 34 (or an image derived therefrom), thereby generating output image content data in the form of a halftone image 42.

The input image 34 may include one or more of text, graphics, photographic images, and the like, in electronic form. One or more input images 34 may be received in a document 40 to be printed. The document may also include print job parameters that identify one or more of the print media weight, print media dimensions, print speed, print media type, ink area coverage, location of the image to be produced on each side of each sheet, media color, media fiber orientation for fibrous media, print zone temperature and humidity, media moisture content, and media manufacturer. The printing parameters may be incorporated into the printing instructions 32, together with the halftone image(s) 42 generated using the permuted screen(s) 38.

The illustrated inkjet marking device 18 includes one or more printheads 44, 45, 46, 47, generally spaced in a process direction. As used herein, the term “process direction” means the direction of movement of the surface of the print media as it passes the printheads in the marking device and the term “cross-process direction” means a direction that is perpendicular to the process direction in the plane of the print media surface.

Each printhead 44, 45, 46, 47 typically ejects a single color of ink. The inks used are commonly cyan, magenta, yellow and black, referred to as C, M, Y, and K respectively. The illustrated printheads may eject droplets 48 of the ink, in liquid form, directly onto the image-receiving surface of one of the sheets 14 of print media to form the printed image 36, as illustrated in FIG. 1. Alternatively, each printhead ejects ink onto an intermediate transfer member, such as a belt or drum (not shown) from which the formed image is transferred to the print media 14. The liquid ink may be selected from aqueous inks, liquid ink emulsions, pigmented inks, phase change inks in a liquid phase, and gel or solid inks having been heated or otherwise treated to alter the viscosity of the ink for improved jetting.

The printheads 44, 45, 46, 47 typically each include an array of individual inkjets (nozzles) 50 through which the drops of ink are ejected across an open gap to the sheet surface to form an ink image 36 during printing. In an inkjet printhead, individual piezoelectric, thermal, or acoustic actuators generate mechanical forces that expel the ink through each nozzle, in a faceplate of the printhead. The actuators expel an ink drop in response to an electrical signal. The locations where the ink drops land are sometimes called “ink drop locations,” “ink drop positions,” or “pixels.” In some embodiments, the magnitude, or voltage level, of the firing signals affects the amount of ink ejected in an ink drop (as in multibit halftone images). In another embodiment, the amount of ink ejected is fixed, such that an ink drop is either generated (an “on” pixel) or not (an “off” pixel), as in binary halftoning.

Each printhead 44, 45, 46, 47 may include one or more rows of inkjets 50, arranged in the cross-process direction. When more than one row is used, the nozzles in one row may be offset from those in another row to increase the number of pixels (dots) per inch which can be achieved in the printed image 36.

The controller 30 processes the input image 34 to generate the halftone image 42. This may include identifying which of the inkjets 50 should be operated to eject a pattern of ink drops at particular locations on the image receiving surface to form an ink image 36. This includes converting the input image from contone values, which can assume a wide range of values, to more discrete halftone values, such as binary values, or up to five possible values. The firing signal for the printheads is generated by the controller 30, with reference to the input image, using the permuted halftone screen 38 or screens, e.g., one permuted screen for each of the color separations C, M, Y, and K. The printing operation then involves the placement of ink drops on an image receiving surface of the print media with reference to the halftone image 42.

As will be appreciated, the input image 34 may undergo one or more preprocessing steps prior to generation of the halftone image 42. Such preprocessing steps are known in the art and may include conversion of the input image from a device-independent color space (e.g., RGB) to a device-dependent color space (e.g., CMYK), correction of skew (particularly in the case of text documents), changing, e.g., reducing the pixel resolution, rescaling the contone values, and the like. For ease of reference, the term “input image” is used to refer to the contone image 34 before and after any preprocessing.

Each permuted screen 38 includes an array of predefined threshold values, one threshold value for each pixel of an array of pixels. Each permuted halftone screen 38 is generated from an original halftone screen 52, to compensate for defective inkjets in the inkjet marking device 18. As used herein, defective inkjets are inkjets which do not produce any drops of ink, or which produce drops of ink irregularly, or produce displaced ink drops, or otherwise do not perform in accordance with the firing signals. At any one time, zero, one, or more of the inkjets may be defective. The number and positions of the defective inkjets may vary over time, e.g., when defective inkjets become unclogged during a periodic cleaning or when inkjets become clogged through lack of use or aggregation of impurities in the ink. The current locations of known defective inkjets may be stored in a list, table, or other data structure 53.

A sensor device 54 may be located adjacent to the print media path 26, downstream of the printheads 44, 45, 46, 47. The sensor device 54 generates sensor data 56 by examining one or more printed images 36. The acquired sensor data 56 can be used to identify any defective inkjets. The sensor device 54 may be a full width sensor device, i.e., have a width sufficient to provide a reading area which is greater than or equal to the width of a sheet 14 in the cross-process direction. Examples of full width array sensors are described, for example, in U.S. Pub. No. 20050240366 A1. Such devices apply light to the image forming area of a sheet being conveyed on the paper path from light-emitting elements, e.g., LEDs, in the sensor device 54 and receive reflected light with photodetecting elements in the sensor device. The sensor device 54 can acquire color or density measurements, which may be obtained from intensities of spectral components of the reflection light. The sensor device 54 outputs the sensor data 56, such as the raw sensor measurements or information based thereon. The sensor data can be attributed to specific pixels of the printed image 36 and used to identify the defective inkjets, e.g., by comparing the sensor measurements with the halftone image 42 which was used to generate the printed image 36.

To facilitate identifying defective inkjets 48, a test pattern 58 may be used as the halftone image 42. The test pattern 58 can be constructed to ensure that all the inkjets 50 of each printhead are fired at least once, e.g., in a predetermined sequence, to generate a printed test image 36 or a sequence of test images. For example, the test pattern 58 may be a halftone image containing line segments (rows of “on” pixels) extending in the process direction, one line segment for each inkjet. If the line segment is missing or displaced by more than a predetermined amount, the corresponding inkjet is considered defective. In addition to the line segments, the test pattern 58 may include location markers, e.g., a group of “on” pixels, which are used to correlate the printed line segments with the inkjets which generated them.

In another embodiment, the system 10 may use input images 34 to identify defective jets. For example, reference marks may be added, in different locations, to each of a sequence of input images 34 and their presence or absence in the printed images 36 detected using the sensor device. Over the course of printing a number of images, locations of defective inkjets can be identified.

In another embodiment, the defective jets may be identified offline, e.g., by a human observer. The observer may identify the missing jets by viewing a magnified version of the printed test image 36. U.S. Pub. No. 20140333691 A1 to Taylor, et al., incorporated herein by reference, describes one example method.

As illustrated in FIG. 2, the exemplary controller 30 includes memory 60 storing software instructions 62 for generating the permuted halftone screen 38 from the original halftone screen 52 and using the permuted screen to generate a halftone image 42. A processor 64 executes the instructions 62. The illustrated instructions 62 include a defective jet detector 66, a screen permutation component 68, a screen output component 70, and a halftone image generator 72.

The defective jet detector 66 may receive sensor data 56 from the sensor device 54 and determine the locations of each of the defective jets based thereon, e.g., by comparing the sensor data with the test pattern 58 (or an input image 34, if used). Alternatively, or additionally, the defective jet detector 66 receives defective jet information generated offline, e.g., by a human observer. The defective jet detector 66 stores the locations of the defective jets in the table 53. For example, for each pixel location in the cross-process direction, the table stores a binary value, e.g., a “0” for an operational inkjet and a “1” for a defective inkjet or vice versa. The table may include one row for each color separation, or separate tables or lists may be provided for each.

The screen permutation component 68 generates a permuted screen 38 from the original screen 52. The screen permutation component 68 identifies those column(s) of pixels in each original screen 52 corresponding to defective inkjets recorded in the table 53. Then, threshold values of neighboring pixels in the original screen are swapped with the threshold values of pixels in the identified “defective” columns, with the aim of increasing the threshold values in the defective columns, so that the corresponding inkjets 50 are less likely to fire. This can be achieved without significantly impacting the appearance of the printed image to the naked eye, using a protocol as described in greater detail below.

For light to medium area coverages, it is possible to have virtually no ink provided by the defective jets. In the case of 100% area coverage, all jets are commanded to fire and thus no compensation for defective jets can be achieved. One way to account for this is to configure the printheads to provide 100% coverage using fewer than all the jets. For example, the printheads could operate in a no more than 85% jets firing mode, so that very few drops are commanded to be fired from defective jets.

The screen output component 70 stores the permuted screen 38 in memory 60 for use when an input image 34 is to be printed. The screen output component 70 may also be configured for outputting the test pattern 58 to the marking device 18 for printing on print media 14, for detection of defective inkjets.

Where an original input image 34 is used instead of a test pattern 58 for detecting defective jets, the halftone image generator 72 may add additional marks to the input image before or after using the original screen 52 to generate a halftone image 42 from the input image 34, which is then sent to the marking device for printing on print media 14.

The halftone image generator 72 may also be configured for subsequently generating a halftone image 42 from an input image 34 using the permuted halftone screen 38. The output component 70, or a separate component, outputs printing instructions 32, including the halftone image 42, to the marking device 18.

The illustrated controller 30 also includes one or more input/output (I/O) devices 80, 82, for receiving the test pattern 58, digital input image 34, original screen(s) 52, sensor data 56, user instructions, and the like, and for outputting information, such as the printing instructions 32 and control signals to various components of the printing device. The various hardware components 60, 64, 80, 82 of the controller 30 may be communicatively connected by a data/control bus 84. A user input device 86, such as a keyboard, touch screen, or the like may be communicatively connected to the controller 30 for providing user instructions, such as a request to print an input image, a request for the controller to run a procedure for generating a permuted screen 38, and the like.

The controller 30 may include one or more computing devices, such as a PC, such as a desktop, laptop, server computer, cellular telephone, tablet computer, microprocessor, GPU, FPGA combination thereof, or other computing device capable of executing instructions for performing the exemplary method described herein.

The memory 60 may represent any type of non-transitory computer readable medium such as random access memory (RAM), read only memory (ROM), magnetic disk or tape, optical disk, flash memory, or holographic memory. In one embodiment, the memory 60 comprises a combination of random access memory and read only memory. In some embodiments, the processor 64 and memory 60 may be combined in a single chip.

The digital processor device 64 can be variously embodied, such as by a single-core processor, a dual-core processor (or more generally by a multiple-core processor), a digital processor and cooperating math coprocessor, a digital controller, or the like.

The interface 80 allows the controller 30 to communicate with external devices via a computer network, such as a local area network (LAN) or wide area network (WAN), or the internet, and may comprise a modulator/demodulator (MODEM) a router, a cable, and/or Ethernet port.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

An exemplary protocol will now be described for generating the permuted screen 38. The protocol may include a sequence of software instructions to be performed in a specified order which specify permutations of threshold values in the screen to be performed when certain conditions are met. The permutations can be performed off-line (i.e., not during printing) in a sequence of repeated permutations. Once complete, the permuted screen 38 avoids or minimizes use of the defective jets.

The protocol aims to alter the halftoning screen 52 to decrease the amount of ink deposited by defective jets and increase the amount of ink used by the neighbors. This is accomplished by permuting the screen threshold values for defective jets into different locations.

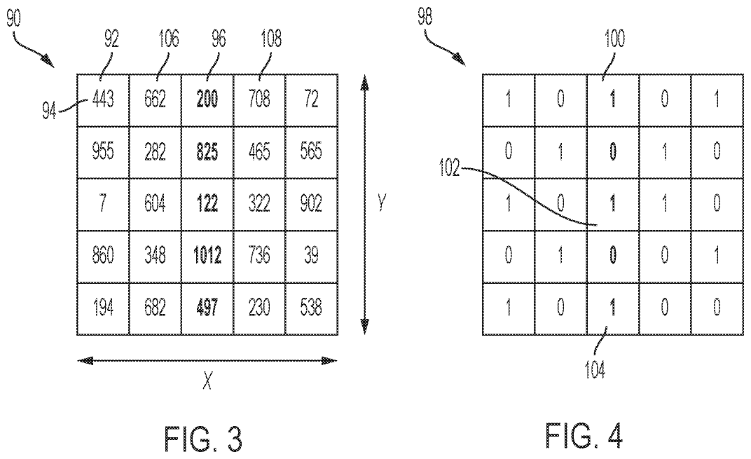

FIG. 3 illustrates a small section 90 of an exemplary original halftone screen 52, where X indicates the cross-process direction and Y indicates the process direction. The illustrated section 90 is in the form of an array of columns and rows, which are perpendicular to the columns. Each pixel or cell 92 of the screen 52 includes a threshold value 94 selected from a range of possible contone values. In halftoning, a jet is fired if the pixel value of the input image is above the threshold value. In this example, the contone values range from 0 to 1025, inclusive, although other minimum and maximum values may be employed. Thus, for example, for the K color separation of the input image, 1025 corresponds to maximum black and 0 to white, with values in between corresponding to shades of gray. The ink jet screens generally have a dither pattern containing high frequencies. This means that a cell with a high threshold value, closer to the maximum, is more likely to have a neighboring cell with a lower threshold value, closer to 0. This makes swapping the threshold values of neighboring cells in the same row of the screen an effective method for increasing the threshold values for a defective ink jet. In FIG. 3, a defective inkjet is represented by a first column 96 of cells with threshold values highlighted in bold.

FIG. 4 illustrates a corresponding portion 98 of the halftone image 42 generated from portion 90. For a constant input gray level of 512, first, third and fifth locations 100, 102, 104 of the first column 96 would try to fire a drop (in the case of a binary halftone) as they all have thresholds below 512. However, due to the defective inkjet, ink drops are not observed in these locations in the resulting image.

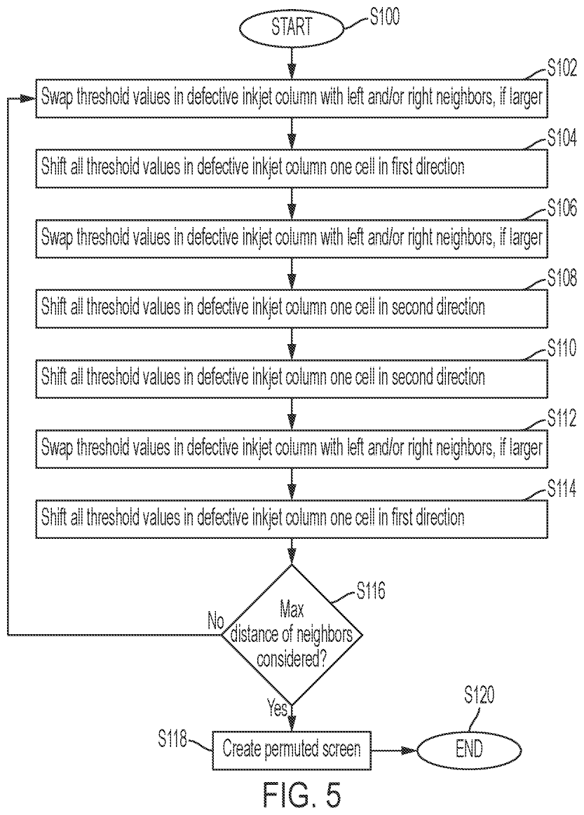

FIG. 5 illustrates an exemplary protocol which can be performed by the screen permutation component 68 of FIG. 2. The method starts at S100.

At S102, threshold values in the first column 96 are swapped with their nearest neighboring pixels to the left and right (i.e., in the same row, in respective columns 106 and 108), so that the center column 96 takes the largest value of it and its nearest neighbors. In the exemplary protocol, the threshold value of a defective jet is swapped with a nearest neighbor that has a larger threshold value. If both nearest neighbors have larger threshold values, then the threshold value in the defective jet column is swapped with the smaller of its two next cell neighbors. If the new threshold value of the defective jet cell post swapping is still larger than that of the other neighbor, a second swap is performed. This method of swapping helps to ensure that the left/right bias of drop placement of the original screen is locally preserved. Thus, for example, in the uppermost row in the original screen portion of FIG. 3, threshold values 662 and 708 are both larger than 200. In a first swap, 200 is exchanged with 662, moving 662 to the defective inkjet column 96 and 200 to column 106. Then, 662 is swapped with 708, resulting in 708 in the defective inkjet column.

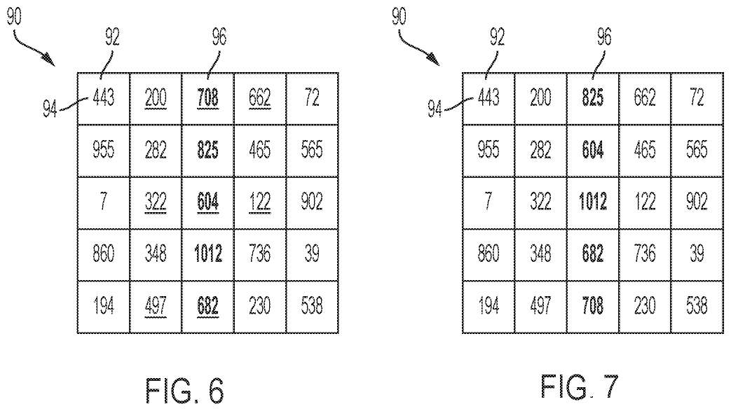

FIG. 6 illustrates the screen portion 90 following S102. Threshold values that have been changed are shown underlined. It can be seen that none of the threshold values in the center (missing jet) column 96 is now below 512. A 50% gray halftone will not print any drops using that defective jet. However, for darker tones, some of the missing jet cells may still instruct the defective jets to fire.

In the first step S102, only the immediate left and right neighbors are used in the swaps. In subsequent steps, to improve performance, the threshold values for the defective jet are swapped with other neighbors. In one embodiment, the nearest neighbors are extended to include the nearest neighbors on a diagonal to the defective jet cell. Thus, for example, the threshold 682 in the fifth row of FIG. 6 could be swapped with the diagonal threshold 736 to its right, but in the fourth row. To perform this step in a simple, but thorough manner, all of the thresholds in the defective inkjet cells may be moved up (or down) and swapped only with left and right neighbors, under the conditions specified in S102. The defective inkjet row is then moved in the opposite direction, such that all the thresholds in the defective jet row are now in their prior positions, except for those that have been swapped.

For example, at S104, circular shifting the thresholds in the center column 96 in the process direction Y in a first direction (up in the exemplary embodiment) is performed. This means that all the threshold values in the center column move up by one cell, except for the top threshold value, which moves to the bottom. The neighboring, non-defective jet columns do not move in this step. FIG. 7 illustrates the screen portion 90 following S104.

Following step S104, S106 is a repeat of step S102, i.e., swapping left and right neighbors according to the same protocol.

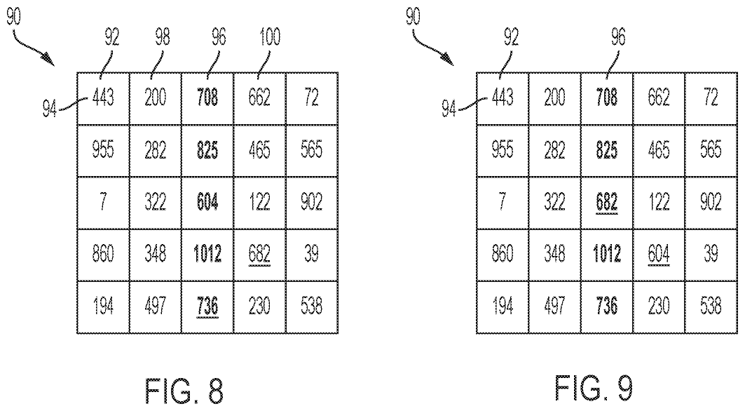

At S108, circular shifting the center row is again performed, as for S104, but in the second, opposite direction (in this case, down). This means that all the threshold values in the center column move down by one cell, except for the bottom threshold value, which moves to the top. FIG. 8 illustrates the screen portion 90 following S108.

In one embodiment, at S110-S114, further circular shifts and swaps are performed as for S104 to S108, but in this case, starting with a shift in the second direction (down in the illustrated embodiment). This effectively enables defective inkjet thresholds to swap with their nearest diagonal neighbors on the row below. FIG. 9 illustrates the screen portion 90 following S114.

The protocol thus far uses only immediate (nearest left and right) neighbors for the swaps. Improvements in image quality can be achieved by swapping threshold values in the center column with more distant neighbors. In one exemplary embodiment, neighbors two cells away on the same row are considered, optionally followed by neighbors three cells away, and so forth. By considering these additional neighbors, further improvements in image quality can be achieved, although with diminishing returns.

In the exemplary embodiment, at S116, a distance to the nearest neighbor to be considered is incremented by 1 cell. If the distance to the neighbors being considered is no more than a preset maximum, such as 2, 3, or 4 away, the method returns to S102. In the next iteration of S102 to S114, the left and right neighbors two cells away involved in the swaps. The iterations continue until at S116, the distance of the neighbors to be considered has reached the preset maximum. The method proceeds to S118.

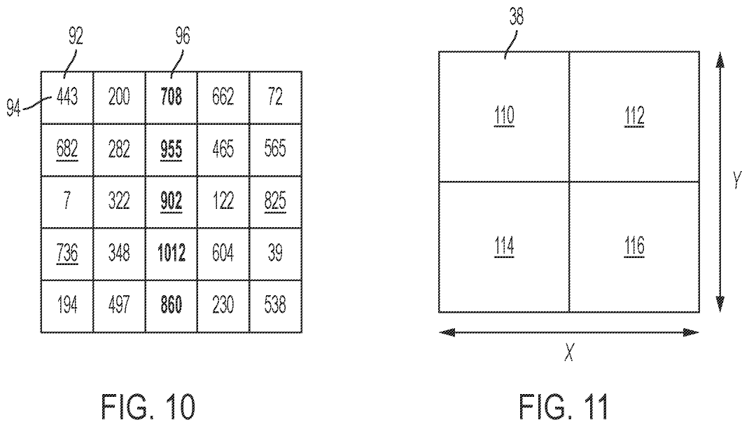

FIG. 10 illustrates the screen portion 90 following the second iteration. In the example screen portion, all the largest threshold values are now in the defective jet column 96. While this is not guaranteed to happen, it is generally observed that a majority of the largest threshold values end up in the defective jet column.

In practice, an original screen 52 may have greater than 50 columns, or greater than 100 columns, or up to 1000 columns, e.g., 256 columns, and a similar number of rows, allowing using the neighbors three (or more) away in generating the permuted screen.

Further permutations are also contemplated. For example, thresholds two (or more away on the diagonal) could be considered by circularizing the defective inkjet column up (or down) by two spaces, then repeating step S102 using the thresholds two spaces away on the same row for any permitted swaps.

In some cases, the original screen 52 is formed by repeating a smaller sub-screen, two or more times in the cross-process direction and/or two or more times in the cross-process direction. In this case, each of the sub-screens in the cross-process direction is processed separately, as described for S102-S116 to generate a respective permuted sub-screen. As will be appreciated, there may be different numbers/locations of defective columns in each sub-screen. Where no defective inkjets are found for one or more of the sub-screens, the original sub-screen is used as the permuted sub-screen.

At S118, in the case where an original screen is formed by repeating a generic sub-screen in the cross-process direction to encompass an entire input image, the permuted screen 38 is formed from a set of permuted sub-screens, as illustrated in FIG. 11. In the illustrated example, the final permuted screen 38 is derived from two sub-screens 110, 112 in the cross process direction X, where screen 110 and 112 could be different permuted versions of the original screen 52, due to differences in the number and/or positions of defective jets in these locations, or one or both could be the same as the generic sub-screen 52, if there are no defective jets detected in that region. The sub-screens may be repeated in the process direction Y. Thus, permuted sub-screen 114 may be identical to permuted sub-screen 110 and permuted sub-screen 116 may be identical to permuted sub-screen 112, since the defective jet column continues in the process direction. As will be appreciated, a permuted screen may be composed of more than four sub-screens, such as six, eight, twelve, sixteen or more sub-screens.

In the case where the generic sub-screen is not tessellated, the permuted screen 38 is simply the output of the last swap or circularizing step in the protocol.

The method ends at S120.

When more than one defective inkjet column 96 is identified in the original screen 52 (or sub-screen), the protocol may be adapted to consider each defective column in turn, or to consider each defective inkjet column in each step. In the rare instances where one defective inkjet column 96 serves as a neighbor for another defective inkjet column, the protocol may result in defective inkjet columns being swapped, in some instances. In one embodiment, the protocol allows this to occur. In another embodiment, swapping of two defective inkjet column threshold values may be prevented.

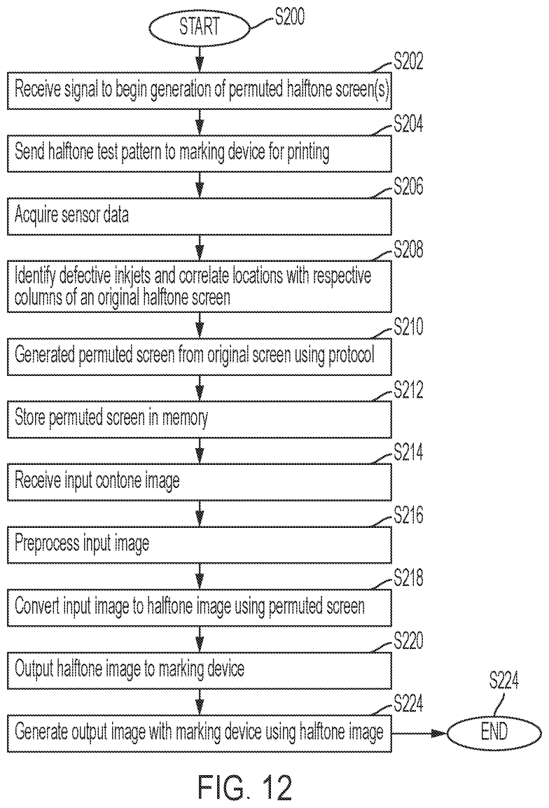

FIG. 12 illustrates a printing method which includes generating and using a permuted halftone screen or screens 38, which can be performed in the printing system of FIGS. 1 and 2. The method starts at S200.

At S202, a signal to begin a permuted halftone screen generation process may be received by the controller 30. The signal may be received from a user, via the user interface 86, or generated by a timer, which provides the signal at predetermined intervals, or initiated after a printhead cleaning operation is performed, and/or at any convenient time.

At S204, a halftone test pattern 58 is sent to the marking device 18 for printing. The test pattern may include halftone dots to be printed by each of the inkjets. Alternatively, if input images 34 are to be used for defective jet detection, additional marks may be incorporated in the input image or halftone image 42. The halftone test pattern 58 (or modified halftone image 42) is sent to the marking device 18, which prints an image 36 on print media 14.

At S206, sensor data 56 for the printed image 36 may be acquired and output, e.g., by the sensor device 54. If a sensor device is not used, at S206 another method of obtaining defective inkjet information may be performed.

At S208, the sensor data 56 is received, e.g., from the sensor device 54, and used to identify defective inkjet locations, e.g., by the defective jet detector 66. For each color separation, columns 96 of the original halftone screen 52 that correspond to the locations of the respective defective jets are stored, e.g., in the table 53.

At S210, a permuted screen 38 is generated from the original screen 52, e.g., using a protocol as described for FIG. 5. For a multicolor marking device, a permuted screen 38 is generated from a respective original screen 52 for each printhead 44, 45, 46, 47. Where the original sub-screen is tessellated, multiple permuted sub-screens 110, 112, etc. may be generated and assembled to form the permuted screen 38.

At S212, the permuted screen 38 is stored in memory 60 for use when an input image 34 is to be converted to a halftone image or images.

In one embodiment, the permuted screen(s) 38 may be validated, e.g., by processing a contone test image (not shown) with the permuted screen(s) 38, printing the halftone image(s) 42 generated, and evaluating the resulting printed test image 36, e.g., by a human observer. Provided that the observer is satisfied, the permuted screen(s) are validated, otherwise, further operations may be performed, such as cleaning one or more of the printheads and repeating the preceding steps, or making minor (e.g., manual) adjustments to the permuted screen.

At S214, an input image 34 is received into memory 60 and at S216 may undergo one or more preprocessing steps.

At S218, the optionally-preprocessed input image 34 is converted to a halftone image or images 42 (i.e., halftoned), by the halftone image generator 72, using the permuted screen or screens 38.

The permuted halftone screen 38 is used in the same manner as a conventional halftone screen but has the benefit of performing the missing jet compensation with no further processing or additional hardware cost required. Thus, a standard halftoner 72 can be used to perform S218. This is extremely useful in lower cost systems where resources are a premium or in systems with lower cost processors which do not have enough computing power to perform more complex missing jet algorithms. S218 may thus include comparing each contone value with the corresponding threshold value of the permuted screen and, if it is greater, the halftone image generated indicates that an ink drop should be generated at the corresponding location. For multicolor printing, a halftone image 42 may be generated for each color separation using a respective permuted screen 38.

At S220, the halftone image(s) 42 is/are sent to the marking device 18 for printing by respective printheads.

At S222, the halftone image 42 is rendered on print media 14, by the marking device.

The method ends at S224 or may return to S202 after a period of time. In one embodiment, the permuted screen 38 may be used as the original screen 52 when a subsequent permuted halftone screen generation protocol is initiated. In another embodiment, the original screen 52 is used each time a permuted halftone screen generation process is initiated at S202.

The method illustrated in FIG. 5 and/or FIG. 12 may be implemented, at least in part, in a computer program product that may be executed on a computing device such as the illustrated controller. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the controller 30 (for example, an internal hard drive of RAM), or may be separate (for example, an external hard drive operatively connected with the controller 30), or may be separate and accessed via a digital data network such as a local area network (LAN) or the Internet (for example, as a redundant array of inexpensive or independent disks (RAID) or other network server storage that is indirectly accessed by the controller 30, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 5, can be used to implement the method for generating a permuted screen and/or using the permuted screen. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Several advantages of the exemplary system and method may be noted:
1) The method incurs a simple and low resource requirement which allows creation of modified screens that simulate missing jet compensation. The protocol of FIG. 5 only needs to be performed once, offline, for each missing jet table 53, rather than for each image 34.
2) Since it can be performed offline, only once, before multiple prints are generated, it is not significant if the protocol takes considerable computational time, such as up to one second or a few seconds, as it does not hold up the printing process.
3) No additional hardware (e.g., FPGA/GPU) or software (CPU realtime) resources are required to perform missing jet compensation once the permuted screen has been generated.
4) The method is compatible with various scalar halftoning methods, including binary and multi-drop halftoning.
5) Performance is similar to that of existing missing jet algorithms for image quality in pictures and graphics.

It should be noted that the method is not generally compatible with vector halftoning, since this method does not permit use of permuted screens for each color separation. Additionally, a slight text degradation may be observed in some images. For example, if an edge pixel of a character lands on a defective jet then the character may be slightly thinner in this instance. Single pixel lines (e.g., 1/1200 inch) that land on a defective jet can disappear completely. However, the advantages generally outweigh the disadvantages by enabling compensation for defective inkjets in low cost/low computing power systems.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for compensating for defective ink jets comprising:
for an original halftone screen including cells arranged in columns and rows, each cell comprising a threshold value, identifying a first column in the original halftone screen corresponding to a defective inkjet in a marking device;
generating a permuted halftone screen from the original halftone screen with a protocol which includes:
(a) for each row in the original halftone screen, providing for swapping a threshold value of a cell in the identified first column with threshold values in cells of neighboring columns, such that the first column assumes the largest threshold value of: the threshold value in the identified first column, a threshold value in a first of the neighboring columns, and a threshold value in a second of the neighboring columns; and
storing the permuted screen for halftoning an input image to be printed by the marking device.

2. The method of claim 1, wherein in (a), where the threshold values in the cells of the first and second neighboring columns are both larger than the threshold value of the cell in the identified first column, the protocol includes swapping the threshold value of the cell in the identified first column with a smaller one of the threshold values in the cells of the first and second of the neighboring columns, followed by swapping the threshold value currently in the cell in the identified first column with the threshold value in the other of the first and second neighboring columns.

3. The method of claim 1, wherein the protocol further includes:
(b) circularizing the threshold values in the first column in a first direction;
(c) after step (b), repeating step (a);
(d) circularizing the threshold values in the first column in a second direction, opposite to the first direction.

4. The method of claim 3, wherein the protocol further includes:
(e) circularizing the threshold values in the first column in the second direction;
(f) after step (e), repeating step (a); and
(h) circularizing the threshold values in the first column in the first direction.

5. The method of claim 1, wherein the protocol includes at least two iterations, wherein in a first of the iterations, the neighboring columns are each spaced from the first column by one cell, and in a second of the iterations, the neighboring columns are each spaced from the first column by more than one cell.

6. The method of claim 5, wherein in the second of the iterations, the neighboring columns are each spaced from the first column by two cells.

7. The method of claim 6, wherein in a third of the iterations, the neighboring columns are each spaced from the first column by three cells.

8. The method of claim 1, wherein the original screen comprises a first row of sub-screens, the method comprising performing the protocol for each of the sub-screens in the first row that include a first column corresponding to a respective defective inkjet in the marking device and assembling the permuted sub-screens to form the permuted screen.

9. The method of claim 8, wherein the original screen comprises a plurality of rows of sub-screens, the method comprises repeating the permuted sub-screens to form a plurality of rows of the permuted screen.

10. The method of claim 1, wherein the marking device comprises a plurality of printheads, a first of the printheads ejecting a first ink through respective inkjets and a second of the printheads ejecting a second ink through respective inkjets, the method including generating a first permuted halftone screen from the original halftone screen with the protocol to compensate for defective ink jets in the first printhead and generating a second permuted halftone screen from the original halftone screen or from another halftone screen with the protocol to compensate for defective ink jets in the second printhead.

11. The method of claim 1, wherein step (a) is performed with a processor including hardware.

12. The method of claim 1, further comprising detecting the defective inkjets, the detecting including rendering a halftone test pattern with the marking device to generate a printed image and evaluating the printed image.

13. The method of claim 1, wherein the identifying of the first column in the original halftone screen corresponding to a defective inkjet includes accessing a data structure which lists pixels in the original halftone screen corresponding to the defective inkjet.

14. The method of claim 1, further comprising halftoning an input image with the permuted screen to generate a halftone image and printing an output image with the marking device, using the halftone image.

15. A computer program product comprising a non-transitory recording medium storing instructions, which when executed on a computer, causes the computer to perform the method of claim 1.

16. A printing system comprising instructions for performing the method of claim 1 and an ink jet marking device which receives a halftone image generated with the permuted halftone screen.

17. A printing system comprising:
a marking device comprising inkjets; and
a controller, in communication with the marking device, the controller storing instructions which:
for an original halftone screen including cells arranged in columns and rows, each cell comprising a threshold value, identify a first column in the original halftone screen corresponding to a defective inkjet in the marking device;
generate a permuted halftone screen from the original halftone screen with a protocol which includes, for each row in the original halftone screen, providing for swapping a threshold value of a cell in the identified first column with threshold values in cells of neighboring columns, such that the first column assumes the largest threshold value of: the threshold value in the identified first column, a threshold value in a first of the neighboring columns, and a threshold value in a second of the neighboring columns; and
store the permuted screen for halftoning an input image to be printed by the marking device.

18. The printing system of claim 17, wherein the marking device comprises a plurality of printheads, each of the printheads ejecting a respective ink from inkjets and wherein the instructions include, for each of the printheads, generating a respective permuted screen with the protocol.

19. A method for compensating for defective ink jets of a marking device when printing an image comprising:
providing a permuted halftone screen which has been generated from an original halftone screen, the original screen comprising an array of threshold values, with a protocol which includes swapping ones of the threshold values, each corresponding to a defective inkjet, with neighboring threshold values that are larger; and
halftoning an input image using the permuted screen, wherein the halftoning comprises comparing contone values of the input image with threshold values in the permuted screen to generate a halftone image.

20. The method of claim 19, further comprising:
providing an original screen comprising an array of threshold values; and
with the protocol, swapping ones of the threshold values, each corresponding to a defective inkjet, with neighboring threshold values that are larger.
